(19) United States
(12) Patent Application Publication
(10) Pub. No.: US 2026/0289675 A1
(43) Pub. Date: Sep. 24, 2026

(54) TECHNOLOGIES FOR ARTIFICIAL INTELLIGENCE ENABLED CONVERSATIONAL FINANCIAL ADVISOR WITH REAL-TIME VISUALIZATION

(71) Applicant: Arghya Mondal, Berkeley, NJ (US)

(72) Inventor: Arghya Mondal, Berkeley, NJ (US)

(21) Appl. No.: 19/573,528

(22) Filed: Mar. 20, 2026

Related U.S. Application Data
(60) Provisional application No. 63/775,898, filed on Mar. 21, 2025.

(51) Int. Cl. G06Q 40/06; H04L 51/02; H04L 51/21

(52) U.S. Cl. CPC G06Q 40/06; H04L 51/02; H04L 51/21

(57) ABSTRACT

Technologies for an artificial-intelligence-enabled conversational financial advisor with real-time visualization include a computing device that establishes a conversation session between a client computing device and a large language model. The conversation session may be a natural language session such as text or voice. The computing device monitors the conversation session for predetermined data categories and extracts data items from the conversation. The computing device further generates interactive data views based on the extracted data items and presents the interactive data views to the client computing device. Other embodiments are described and claimed.

### CROSS-REFERENCE TO RELATED APPLICATION

This application claims the benefit of and priority to U.S. Patent Application No. 63/775,898, entitled “TECHNOLOGIES FOR ARTIFICIAL INTELLIGENCE ENABLED CONVERSATIONAL FINANCIAL ADVISOR WITH REAL-TIME VISUALIZATION,” which was filed on Mar. 21, 2025, and which is incorporated herein by reference in its entirety.

### BACKGROUND

Typical financial planning tools require structured, manual data entry, making it difficult for users to interactively explore different financial scenarios. Current financial chatbots lack dynamic real-time visualization and meaningful two-way conversations that mimic human financial advisors. Furthermore, existing solutions do not integrate seamlessly with customer relationship management (CRM) systems to personalize conversations or intelligently match users with financial professionals based on conversational insights.

### SUMMARY

According to one aspect of the disclosure, a computing device for real-time data visualization includes a conversational module, an input processing module, and a real-time visualization engine. The conversational module is to establish a conversation session between a client computing device and a large language model. The input processing module is to monitor the conversation session for one or more predetermined data categories and extract a first data item from the conversation session in response to monitoring of the conversation session. The real-time visualization engine is to generate a first interactive data view based on the first data item in response to extraction of the first data item and present the first interactive data view to the client computing device in response to generation of the first interactive data view.

In some embodiments, the conversation session comprises an interactive session, and to monitor the conversation session, to extract the first data item, to generate the first interactive data view, and to present the first interactive data view comprises a first interaction cycle. The first interaction cycle is performed while the interactive session is active. In some embodiments, the interactive session comprises a plurality of interaction cycles, the plurality of interaction cycles including the first interaction cycle.

In some embodiments, the computing device further includes a customer relationship management (CRM) integrator to retrieve financial data specific to a user of the client computing device from a customer relationship management data source. To establish the conversation session comprises to prompt the large language model with the financial data specific to the user.

In some embodiments, the computing device further comprises an advisor matching system to identify a specialized financial planning category in response to the monitoring of the conversation session; match the specialized financial planning category with an expertise database of the computing device to identify a matching financial advisor; and present the matching financial advisor to the client computing device in response to a match of the specialized financial planning category.

In some embodiments, to establish the conversation session comprises to establish a natural language session, wherein the natural language session comprises voice or text. In some embodiments, to establish the conversation session further comprises to generate a prompt for the large language model, wherein the prompt comprises contextual data associated with a user of the client computing device. In some embodiments, the contextual data is received from an advisor computing device or from a customer relationship management data source.

In some embodiments, to monitor the conversation session for the one or more predetermined data categories comprises to monitor the conversation session for financial information. In some embodiments, the financial information comprises a current savings amount, a target retirement age, a risk tolerance, or an expected rate of return.

In some embodiments, to monitor the conversation session for the one or more predetermined data categories comprises to monitor the conversation session for user interest. In some embodiments, to monitor the conversation session for user interest further comprises to monitor an application focus area selected by a user of the client computing device. In some embodiments, to monitor the conversation session for user interest further comprises to monitor a verbal indication of interest of the conversation session. In some embodiments, to present the first interactive data view comprises to select the first interactive data view based on the user interest.

In some embodiments, to generate the first interactive data view in response to the extraction of the first data item comprises to generate a chart, a graph, or a table based on the first data item. In some embodiments, to generate the first interactive data view further comprises to update a financial calculation based on the first data item and to generate the first interactive data view in response to an update of the financial calculation.

In some embodiments, the input processing module is further to monitor the conversation session by a plurality of listeners, wherein each listener of the plurality of listeners is configured to identify a predetermined data category of the one or more predetermined data categories. The one or more predetermined categories comprises financial data and user interest. The input processing module is further to collect one or more data items from the plurality of listeners. To collect the one or more data items comprises to extract the first data item. The real-time visualization engine is further to generate a plurality of canvases. Each canvas of the plurality of canvases comprises an interactive data view based on one or more of the data items from the plurality of listeners. To generate the plurality of canvases comprises to generate the first interactive data view. The real-time visualization engine is further to select the first interactive data view from the plurality of canvases. In some embodiments, to select the first interactive data view comprises to select the first interactive data view based on a first user interest identified by a listener of the plurality of listeners.

In some embodiments, the conversational module is further to update a prompt for the large language model with feedback generated in response to the monitoring of the conversation session.

According to another aspect, a method for real-time data visualization includes establishing, by a computing device, a conversation session between a client computing device and a large language model; monitoring, by the computing device, the conversation session for one or more predetermined data categories; extracting, by the computing device, a first data item from the conversation session in response to monitoring the conversation session; generating, by the computing device, a first interactive data view based on the first data item in response to extracting the first data item; and presenting, by the computing device, the first interactive data view to the client computing device in response to generating the first interactive data view.

In some embodiments, the conversation session comprises an interactive session, and wherein monitoring the conversation session, extracting the first data item, generating the first interactive data view, and presenting the first interactive data view comprises a first interaction cycle, wherein the first interaction cycle is performed while the interactive session is active. In some embodiments, the interactive session comprises a plurality of interaction cycles, the plurality of interaction cycles including the first interaction cycle.

In some embodiments, the method further includes retrieving, by the computing device, financial data specific to a user of the client computing device from a customer relationship management data source; wherein establishing the conversation session comprises prompting the large language model with the financial data specific to the user.

In some embodiments, the method further includes identifying, by the computing device, a specialized financial planning category in response to monitoring the conversation session; matching, by the computing device, the specialized financial planning category with an expertise database of the computing device to identify a matching financial advisor; and presenting, by the computing device, the matching financial advisor to the client computing device in response to matching the specialized financial planning category.

In some embodiments, establishing the conversation session comprises establishing a natural language session, wherein the natural language session comprises voice or text. In some embodiments, establishing the conversation session further comprises generating a prompt for the large language model, wherein the prompt comprises contextual data associated with a user of the client computing device. In some embodiments, the contextual data is received from an advisor computing device or from a customer relationship management data source.

In some embodiments, monitoring the conversation session for the one or more predetermined data categories comprises monitoring the conversation session for financial information. In some embodiments, the financial information comprises a current savings amount, a target retirement age, a risk tolerance, or an expected rate of return.

In some embodiments, monitoring the conversation session for the one or more predetermined data categories comprises monitoring the conversation session for user interest. In some embodiments, monitoring the conversation session for user interest further comprises monitoring an application focus area selected by a user of the client computing device. In some embodiments, monitoring the conversation session for user interest further comprises monitoring a verbal indication of interest of the conversation session. In some embodiments, presenting the first interactive data view comprises selecting the first interactive data view based on the user interest.

In some embodiments, generating the first interactive data view in response to extracting the first data item comprises generating a chart, a graph, or a table based on the first data item. In some embodiments, generating the first interactive data view further comprises updating a financial calculation based on the first data item and generating the first interactive data view in response to updating the financial calculation.

In some embodiments, the method further includes monitoring, by the computing device, the conversation session by a plurality of listeners, wherein each listener of the plurality of listeners is configured to identify a predetermined data category of the one or more predetermined data categories, the one or more predetermined categories comprises financial data and user interest; collecting, by the computing device, one or more data items from the plurality of listeners, wherein collecting the one or more data items comprises extracting the first data item; generating, by the computing device, a plurality of canvases, wherein each canvas of the plurality of canvases comprises an interactive data view based on one or more of the data items from the plurality of listeners, wherein generating the plurality of canvases comprises generating the first interactive data view; and selecting, by the computing device, the first interactive data view from the plurality of canvases. In some embodiments, selecting the first interactive data view comprises selecting the first interactive data view based on a first user interest identified by a listener of the plurality of listeners.

In some embodiments, the method further includes updating, by the computing device, a prompt for the large language model with feedback generated in response to monitoring the conversation session.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for artificial intelligence (AI) enabled conversational financial planning with real-time data visualization;

FIG. 2 is a simplified block diagram of an environment that may be established by the system of FIG. 1; and

FIG. 3 is a simplified block diagram of component structure and method that may be established by the system of FIGS. 1 and 2.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

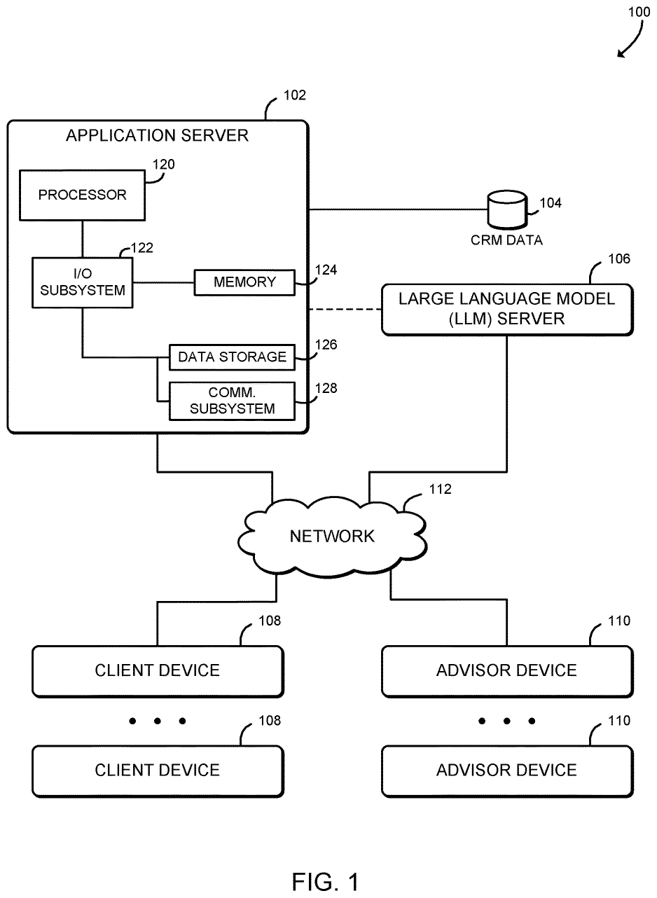

Referring now to FIG. 1, an illustrative system 100 for artificial intelligence (AI) enabled conversational financial planning with real-time data visualization includes an application server 102 in communication with a customer relationship management (CRM) data source 104, a large language model (LLM) server 106, one or more client computing devices 108, and one or more advisor computing devices 110 over a network 112. In use, as described further below, the application server 102 engages users via natural language (e.g., voice or text) input using the LLM server 106, and dynamically generates real-time financial visualizations based on the content of those user conversations. The disclosed system 100 adapts to changing inputs, personalizes interactions and data visualization via integration with the CRM data source 104 and/or other contextual customer data sources, and may suggest relevant financial professionals based on user needs. Accordingly, the system 100 disclosed herein provides an easy-to-use AI-driven financial advisory experience and enables interactive financial planning with dynamic, real-time data visualization. Thus, the system 100 improves upon typical financial tools, which rely on static inputs and structured workflows and thus do not allow real-time adaptation to natural conversations and not provide immediate financial scenario visualization. Additionally, the disclosed system 100 enables dynamic interactions with contextual customer data, which is an improvement over typical CRM-based personalization that is limited to predefined data retrieval.

The application server 102 may be embodied as any type of device capable of performing the functions described herein. For example, the application server 102 may be embodied as, without limitation, a server, a rack-mounted server, a blade server, a workstation, a desktop computer, a laptop computer, a tablet computer, a smartphone, a consumer electronic device, a network appliance, a web appliance, a distributed computing system, a multiprocessor system, and/or any other computing device capable of performing the functions described herein. As shown in FIG. 1, the illustrative application server 102 includes a processor 120, an I/O subsystem 122, memory 124, a data storage device 126, and communication circuitry 128. Of course, the application server 102 may include other or additional components, such as those commonly found in a desktop computer (e.g., various input/output devices), in other embodiments. Additionally, in some embodiments, one or more of the illustrative components may be incorporated in, or otherwise form a portion of, another component. For example, the memory 124, or portions thereof, may be incorporated in the processor 120 in some embodiments. Additionally, in some embodiments, the application server 102 may be embodied as a “virtual server” formed from multiple computing devices distributed across the network 112 and operating in a public or private cloud. Accordingly, although the application server 102 is illustrated in FIG. 1 as embodied as a single computing device, it should be appreciated that the application server 102 may be embodied as multiple devices cooperating together to facilitate the functionality described below.

The processor 120 may be embodied as any type of processor or compute engine capable of performing the functions described herein. For example, the processor may be embodied as a single or multi-core processor(s), digital signal processor, microcontroller, or other processor or processing/controlling circuit. Similarly, the memory 124 may be embodied as any type of volatile or non-volatile memory or data storage capable of performing the functions described herein. In operation, the memory 124 may store various data and software used during operation of the application server 102 such as operating systems, applications, programs, libraries, and drivers. The memory 124 is communicatively coupled to the processor 120 via the I/O subsystem 122, which may be embodied as circuitry and/or components to facilitate input/output operations with the processor 120, the memory 124, and other components of the application server 102. For example, the I/O subsystem 122 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 122 may form a portion of a system-on-a-chip (SoC) and be incorporated, along with the processor 120, the memory 124, and other components of the application server 102, on a single integrated circuit chip.

The data storage device 126 may be embodied as any type of device or devices configured for short-term or long-term storage of data such as, for example, memory devices and circuits, memory cards, hard disk drives, solid-state drives, or other data storage devices. The communication circuitry 128 of the application server 102 may be embodied as any communication circuit, device, or collection thereof, capable of enabling communications between the application server 102, the CRM data source 104, the LLM server 106, the client computing devices 108, the advisor computing devices 110, and/or other remote devices. The communication circuitry 128 may be configured to use any one or more communication technology (e.g., wireless or wired communications) and associated protocols (e.g., Ethernet, Bluetooth®, Wi-Fi®, WiMAX, WebRTC, etc.) to effect such communication.

The CRM data source 104 and the LLM server 106 may be embodied as any type of computation or computer device capable of performing the functions described herein, including, without limitation a server, a rack-mounted server, a blade server, a workstation, a desktop computer, a laptop computer, a tablet computer, a smartphone, a consumer electronic device, a network appliance, a web appliance, a distributed computing system, a multiprocessor system, and/or any other computing device capable of performing the functions described herein. Thus, each of the CRM data source 104 and the LLM server 106 may include components and devices commonly found in a server or similar computing device, such as a processor, an I/O subsystem, a memory, a data storage device, and/or communication circuitry. Those individual components of the CRM data source 104 and the LLM server 106 may be similar to the corresponding components of the application server 102, the description of which is applicable to the corresponding components of the CRM data source 104 and the LLM server 106 and is not repeated herein so as not to obscure the present disclosure. Additionally, similar to the application server 102 described above, one or more of the CRM data source 104 and the LLM server 106 may be embodied as a “virtual server” formed from multiple computing devices distributed across the network 112 and operating in a public or private cloud. Additionally or alternatively, in some embodiments, one or more functions of the application server 102, the CRM data source 104, and/or the LLM server 106 may be containerized, orchestrated, or otherwise performed within the same public or private cloud computing system. Accordingly, although each of the application server 102, the CRM data source 104, and the LLM server 106 are illustrated in FIG. 1 as embodied as separate computing devices, it should be appreciated that the application server 102, the CRM data source 104, and the LLM server 106 may be embodied as a single device and/or multiple devices cooperating together to facilitate the functionality described below.

Similarly, each of the client devices 108 and the advisor devices 110 may be embodied as any type of computation or computer device capable of performing the functions described herein, including, without limitation, a desktop computer, a laptop computer, a notebook computer, a tablet computer, a mobile computing device, a smartphone, a wearable computing device, a server, a rack-mounted server, a blade server, a network appliance, a web appliance, a distributed computing system, a multiprocessor system, a processor-based system, and/or a consumer electronic device. Thus, each client device 108 and/or advisor device 110 includes components and devices commonly found in a personal computer or similar computing device, such as a processor, an I/O subsystem, a memory, a data storage device, and/or communication circuitry. Those individual components of the client device 108 and/or the advisor device 110 may be similar to the corresponding components of the application server 102, the description of which is applicable to the corresponding components of the client device 108 and/or the advisor device 110 and is not repeated herein so as not to obscure the present disclosure.

As discussed in more detail below, the application server 102, the CRM data source 104, the LLM server 106, the client devices 108, and the advisor devices 110 may be configured to transmit and receive data with each other and/or other devices of the system 100 over the network 112. The network 112 may be embodied as any number of various wired and/or wireless networks. For example, the network 112 may be embodied as, or otherwise include, a wired or wireless local area network (LAN), a wired or wireless wide area network (WAN), and/or a publicly-accessible, global network such as the Internet. As such, the network 112 may include any number of additional devices, such as additional computers, routers, and switches, to facilitate communications among the devices of the system 100.

In use, and as described further below, the disclosed system 100

### Accepts Natural Language Input via Voice or Text. the System 100 Extracts and

understands financial data from user statements. The system 100 dynamically updates financial projections in real-time through visual charts. The system 100 engages users in a two-way conversation, for example questioning assumptions and suggesting financial strategies. The system 100 integrates with CRM and other client data repositories to personalize interactions. The system 100 matches users with financial professionals based on insights derived from their conversation and financial needs.

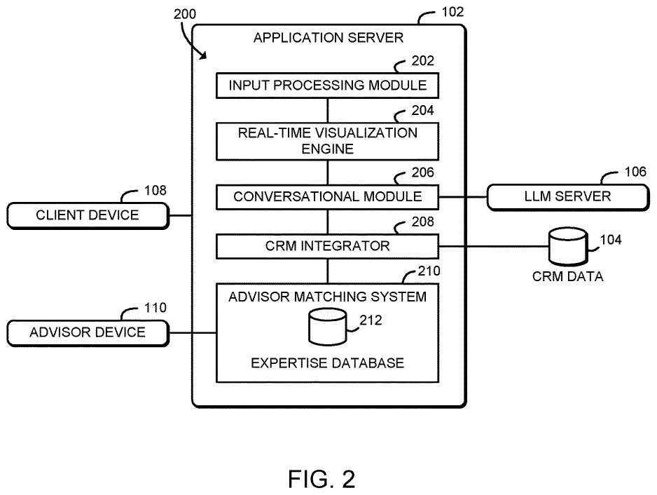

Referring now to FIG. 2, in an illustrative embodiment, the application server 102 establishes an environment 200 during operation. The illustrative environment 200 includes an input processing module 202, a real-time visualization engine 204, a conversational module 206, a CRM integrator 208, and an advisor matching system 210. The various components of the environment 200 may be embodied as hardware, firmware, software, or a combination thereof. As such, in some embodiments, one or more of the components of the environment 200 may be embodied as circuitry or a collection of electrical devices (e.g., input processing circuitry 202, real-time visualization engine circuitry 204, conversational circuitry 206, CRM integrator circuitry 208, and/or advisor matching system circuitry 210). It should be appreciated that, in such embodiments, one or more of those components may form a portion of the processor 120, the I/O subsystem 122, and/or other components of the application server 102.

The input processing module 202 is configured to accept voice or text input. The input processing module 202 is configured to use natural language processing (NLP) to extract financial intent, preferences, and numerical values.

The real-time visualization engine 204 is configured to generate interactive financial charts based on extracted data. The real-time visualization engine 204 is configured to update charts dynamically as users modify their inputs or assumptions. The real-time visualization engine 204 is configured to allow users to experiment with different financial scenarios in a visual, intuitive manner.

The conversational module 206 is configured to engage users in a natural, AI-driven conversation, for example using the LLM server 106. The conversational module 206 is configured to question assumptions and suggest alternative financial decisions. The conversational module 206 is configured to use AI to analyze conversation history and infer financial goals.

The CRM integrator 208 is configured to retrieve user-specific financial data from CRM systems such as the CRM data source 104 for personalized financial planning. The CRM integrator 208 is configured to customize interactions based on past financial behavior and preferences. CRM integrator 208 is configured to enable financial advisors to preload client information for a tailored experience.

The advisor matching system 210 is configured to maintain a database 212 of financial professionals and their expertise. The advisor matching system 210 is configured to use AI-driven analysis to recommend suitable advisors based on user needs. The advisor matching system 210 is configured to facilitate direct engagement between users and financial professionals.

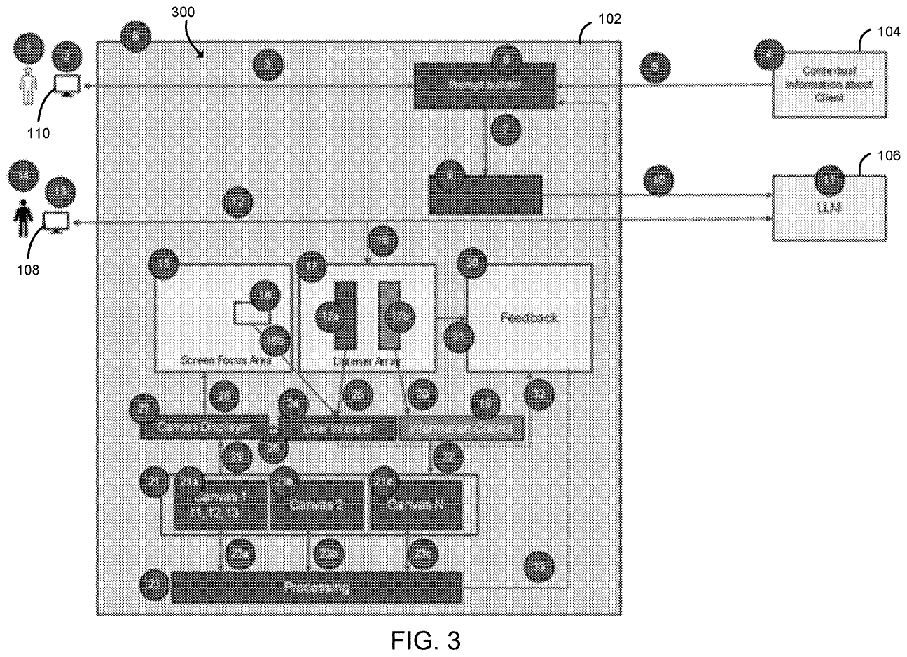

Referring now to FIG. 3, in the illustrative embodiment, the application server 102 establishes a component structure 300 for an application 8 during operation. The various components of the component structure 300 may be embodied as hardware, firmware, software, or a combination thereof. It should be appreciated that, in some embodiments, the components of the structure 300 may include objects, interfaces, methods, functions, interactions, or other functional components that are included in, created by, executed by, performed by, or otherwise managed by one or more components of the environment 200 of the application server 102 as shown in FIG. 2. Accordingly, in some embodiments the application server 102 may execute a method for conversational financial planning with real-time data visualization using functionality provided by the components of the component structure 300.

As illustrated in FIG. 3, a user 1 operates a computer 2, which is illustratively an advisor device 110. The user 1 may be a financial advisor, an assistant, an administrator, or other user acting independently or on behalf of the advisor. Similarly, a user 14 operates a computer 13, which is illustratively a client device 108. The user 14 may be a client, prospective client, customer, end user, or other user of the client device 108. The computer 2 interacts with a prompt builder 6 of the application 8 via an interaction 3. For example, the user 1 may provide, with the advisor device 110, contextual information about the user 14. The advisor device 110 may pull contextual information from one or more external systems 4, such as the CRM data source 104 or other external application, repository, system, or other contextual data source that provides contextual information about the user 14. Contextual data may include, for example, customer relationship information, customer history, and notes about the customer contextual data sources. As shown, this contextual information flows in an interaction 5 between external sources, systems, or applications and the prompt builder 6. In some embodiments, the system 100 may push information from one or more external systems 13, for example pushing contextual information provided by the client device 108. In some embodiments, the advisor device 110 may provide one or more instructions for one or more LLMs to follow, for example one or more instructions to be incorporated by the prompt builder 6 in a prompt to an LLM 11 as described further below.

The prompt builder 6 builds prompts for submission to the LLM 11. This prompt building may be performed multiple times during the course of the interactions between the user 14 and the LLM 11. The prompt builder 6 passes a prompt via an interaction 7 to a communicator 9. The communication 9 relays the prompt to an appropriate LLM 11.

The communicator 9 communicates with one or more LLMs 11, for example one or more LLMs 11 hosted by a remote LLM server 106, locally hosted by the application server 102, and/or other LLM 11. Additionally or alternatively, in some embodiments the communicator may communicate with one or more small language models (SLMs) or other AI-driven dialog technology. The communicator 9 may, for example, establish and manage communication connections (e.g., WebRTC) between the application server 102 and/or the client device 108 with the LLM server 106 or other host for the LLM 11. The communicator 9 may further establish and manage user sessions, and may update sessions and/or terminate sessions as required.

As shown, the communicator 9 communicates with one or more LLMs 11 via an interaction 10. The LLMs 11 may communication with a device 13, which is illustratively a client device 108, via a connection/channel 12 established between the LLM 11 and the device 13. The channel 12 may be used to pass voice and data or otherwise pass natural language communication between the LLM 11 and the device 13. The channel 12 may be tunneled, proxied, or otherwise managed by the application 8 or other component of the application server 102.

As shown, the application 8 may provide and/or monitor a screen focus area 15 of the device 13. The screen focus area may be embodied as an application window or other area within the screen of the device 13 in which the user 14 is visually shown one or more charts, pictures, slides, and/or other information in real time as the natural language conversation with the LLM 11 unfolds. The user 14 may use a pointer (e.g., a mouse, a touch interface, a verbal description, or other interface technique) to identify, zoom in, and/or convey a portion 16 of the screen to the application. The application 8 may communicate the user-selected screen area 16 via an interaction 16b to a user interest collector 24.

As shown, the application 8 includes an array of listeners 17, and each of the array of listeners 17 listens, parses, or otherwise monitors the conversation between the user 14 and the LLM 11. For example, one or more listeners 17a may listen for the user's topic of interest and shift in interest as the conversation unfolds. As another example, an array of listeners 17b may listen for specific informational inputs. As yet another example, an array of listeners 17c may listen for user sophistication. As shown, the array of listeners 17 may listen to the conversation occurring over the channel 12 via an interaction 18.

An input collector 19 collects inputs from the conversation 12 and sends the information to one or more appropriate canvases 21. For example, in an interaction 20, the input collector 19 may collect informational inputs from the listeners 17b.

As shown, the application 8 includes or otherwise manages a collection of canvases 21 (e.g., canvases 21a, 21b, 21c). Each canvas 21 is embodied as a visual aid that helps the user 14 understand a concept, a scenario, and/or a result of certain inputs and assumptions. For example, a canvas may use a template that takes in informational inputs from information collector 19 and displays the output. Output may be displayed in the form of one or more charts, graphs, tables, or other visual data representations. Accordingly, the application 8 may maintain multiple versions of the same canvas 21, based on different inputs (and thus visualizing different output).

Illustratively, in an interaction 22 the canvases 21 receive some or all of its inputs from the information collected from the conversation 12 by the listener 17b and the information collector 19, as described above.

As shown, each canvas 21 may reach out to a processing unit 23 for processing. For example, the processing unit 23 may perform calculations (e.g., financial calculations), charting, or other processing functions. As shown, each individual canvas 21a, 21b, 21c may establish respective interactions 23a, 23b, 23c with the processing unit 23.

The user interest collector 24 collects (in an interaction 25) the user's interest from the listeners 17a and 16b and communicates the user's interest (in an interaction 26) to a canvas displayer 27. The canvas displayer 27 receives the user interest from the user interest collector 24 and displays an appropriate canvas 21 on the screen focus area 15. The canvas displayer 27 may fetch the appropriate canvas 21 for display on the screen focus area 15, illustratively with an interaction 29. A particular canvas 21 may be displayed in the screen focus area 15 one or more at a time and once or multiple times, and may be swapped in and out based on the flow of the conversation. The selected canvas 21 may be communicated to the screen focus area 15 in an interaction 28, as shown.

A feedback module 30 may receive data from the listener array 17 via an interaction 31, via the user interest collector 25 via an interaction 32, or via the processing unit 23 via an interaction 33. In case the conversation between the user 14 and the LLM 11 strays or needs to be reset or otherwise needs some inputs to steer the conversation, the feedback module 30 receives those from the listeners 17, the user interest collector 25, and/or the processing unit 23, and then communicates to the prompt builder 6 to build a prompt and send that prompt to the LLM 11 via the communicator 9.

It should be understood that one or more operations of the method illustrated in FIG. 3 may be performed sequentially, simultaneously, in parallel, or in any appropriate ordering or relationship. Additionally, although the operations of the application 8 are illustrated in FIG. 3 and described as being performed by various components, it should be understood that in other embodiments those functions may be performed in any other appropriate arrangement of components and/or devices.

Thus, the disclosed system 100 redefines financial advisory services by combining AI-driven conversations, real-time visualization, and CRM-based personalization. The system 100 enables users to explore financial decisions dynamically while engaging in meaningful dialogue that enhances financial literacy and decision-making.

In one illustrative example use case, a user seeking retirement planning advice initiates a conversation with the system 100 via voice input. The system 100 extracts relevant financial information from the natural language conversation, such as the user's current savings, target retirement age, and risk tolerance, and displays dynamic charts forecasting various scenarios based on the extracted relevant financial information. As the user changes preferences, such as adjusting the expected return rate or savings contributions, the system 100 updates the visualization in real-time. Meanwhile, the AI conversational module suggests alternative strategies, such as different investment strategies, push retirement age, reduce expenses, etc. If the system determines that the user requires specialized advice, it recommends an advisor with relevant expertise, such as retirement planning, college planning, etc.

In another illustrative example use case, the system 100 may provide an interactive data view based on existing reports or other information. For example, a user initiates a conversation with the system 100 via text input. The natural language conversation discusses a performance report or other statement, which may be embodied as a PDF file or other pre-generated report that includes graphs, charts, or other relevant financial information. The system 100 monitors the conversation with the user and identifies that the user has asked a question about a subject covered in the performance report. The system 100 identifies a portion of the report such as a chart, graph, or other visual aid that is relevant to the user's question. The system 100 presents this relevant portion of the report in an interactive data view, in real time. For example, the system 100 may extract and present a copy of the visual aid in the canvas or other screen focus area. As another example, the system 100 may provide a bookmark, hyperlink, page number, or other reference to the relevant portion of the pre-generated report, allowing the user to navigate to the relevant portion of the pre-generated report.

1. A computing device for real-time data visualization, the computing device comprising:
a conversational module to establish a conversation session between a client computing device and a large language model;
an input processing module to (i) monitor the conversation session for one or more predetermined data categories and (ii) extract a first data item from the conversation session in response to monitoring of the conversation session; and
a real-time visualization engine to (i) generate a first interactive data view based on the first data item in response to extraction of the first data item, and (ii) present the first interactive data view to the client computing device in response to generation of the first interactive data view.

2. The computing device of claim 1, wherein the conversation session comprises an interactive session, and wherein to monitor the conversation session, to extract the first data item, to generate the first interactive data view, and to present the first interactive data view comprises a first interaction cycle, wherein the first interaction cycle is performed while the interactive session is active.

3. The computing device of claim 1, further comprising:
a customer relationship management (CRM) integrator to retrieve financial data specific to a user of the client computing device from a customer relationship management data source;
wherein to establish the conversation session comprises to prompt the large language model with the financial data specific to the user.

4. The computing device of claim 1, further comprising an advisor matching system to:
identify a specialized financial planning category in response to the monitoring of the conversation session;
match the specialized financial planning category with an expertise database of the computing device to identify a matching financial advisor; and
present the matching financial advisor to the client computing device in response to a match of the specialized financial planning category.

5. The computing device of claim 1, wherein to establish the conversation session further comprises to generate a prompt for the large language model, wherein the prompt comprises contextual data associated with a user of the client computing device, wherein the contextual data is received from an advisor computing device or from a customer relationship management data source.

6. The computing device of claim 1, wherein to monitor the conversation session for the one or more predetermined data categories comprises to monitor the conversation session for financial information, wherein the financial information comprises a current savings amount, a target retirement age, a risk tolerance, or an expected rate of return.

7. The computing device of claim 1, wherein to monitor the conversation session for the one or more predetermined data categories comprises to monitor the conversation session for user interest.

8. The computing device of claim 7, wherein to monitor the conversation session for user interest further comprises to monitor an application focus area selected by a user of the client computing device.

9. The computing device of claim 7, wherein to monitor the conversation session for user interest further comprises to monitor a verbal indication of interest of the conversation session.

10. The computing device of claim 1, wherein to generate the first interactive data view in response to the extraction of the first data item comprises to generate a chart, a graph, or a table based on the first data item.

11. The computing device of claim 10, wherein to generate the first interactive data view further comprises to update a financial calculation based on the first data item and to generate the first interactive data view in response to an update of the financial calculation.

12. The computing device of claim 1, wherein:
the input processing module is further to (i) monitor the conversation session by a plurality of listeners, wherein each listener of the plurality of listeners is configured to identify a predetermined data category of the one or more predetermined data categories, the one or more predetermined categories comprises financial data and user interest, and (ii) collect one or more data items from the plurality of listeners, wherein to collect the one or more data items comprises to extract the first data item; and
the real-time visualization engine is further to (i) generate a plurality of canvases, wherein each canvas of the plurality of canvases comprises an interactive data view based on one or more of the data items from the plurality of listeners, wherein to generate the plurality of canvases comprises to generate the first interactive data view, and (ii) select the first interactive data view from the plurality of canvases.

13. The computing device of claim 12, wherein to select the first interactive data view comprises to select the first interactive data view based on a first user interest identified by a listener of the plurality of listeners.

14. The computing device of claim 1, wherein to generate the first interactive data item comprises to extract a first visual aid from a pre-generated report document, wherein the first visual aid is related to the conversation session.

15. One or more computer-readable storage media comprising a plurality of instructions that in response to being executed cause a computing device to:
establish a conversation session between a client computing device and a large language model;
monitor the conversation session for one or more predetermined data categories;
extract a first data item from the conversation session in response to monitoring the conversation session;
generate a first interactive data view based on the first data item in response to extracting the first data item; and
present the first interactive data view to the client computing device in response to generating the first interactive data view.

16. The one or more computer-readable storage media of claim 15, wherein to monitor the conversation session for the one or more predetermined data categories comprises to monitor the conversation session for financial information.

17. The one or more computer-readable storage media of claim 15, further comprising a plurality of instructions that in response to being executed cause the computing device to:
monitor the conversation session by a plurality of listeners, wherein each listener of the plurality of listeners is configured to identify a predetermined data category of the one or more predetermined data categories, the one or more predetermined categories comprises financial data and user interest;
collect one or more data items from the plurality of listeners, wherein collecting the one or more data items comprises extracting the first data item;
generate a plurality of canvases, wherein each canvas of the plurality of canvases comprises an interactive data view based on one or more of the data items from the plurality of listeners, wherein generating the plurality of canvases comprises generating the first interactive data view; and
select the first interactive data view from the plurality of canvases.

18. A method for real-time data visualization, the method comprising:
establishing, by a computing device, a conversation session between a client computing device and a large language model;
monitoring, by the computing device, the conversation session for one or more predetermined data categories;
extracting, by the computing device, a first data item from the conversation session in response to monitoring the conversation session;
generating, by the computing device, a first interactive data view based on the first data item in response to extracting the first data item; and
presenting, by the computing device, the first interactive data view to the client computing device in response to generating the first interactive data view.

19. The method of claim 18, wherein monitoring the conversation session for the one or more predetermined data categories comprises monitoring the conversation session for financial information.

20. The method of claim 18, further comprising:
monitoring, by the computing device, the conversation session by a plurality of listeners, wherein each listener of the plurality of listeners is configured to identify a predetermined data category of the one or more predetermined data categories, the one or more predetermined categories comprises financial data and user interest;
collecting, by the computing device, one or more data items from the plurality of listeners, wherein collecting the one or more data items comprises extracting the first data item;
generating, by the computing device, a plurality of canvases, wherein each canvas of the plurality of canvases comprises an interactive data view based on one or more of the data items from the plurality of listeners, wherein generating the plurality of canvases comprises generating the first interactive data view; and
selecting, by the computing device, the first interactive data view from the plurality of canvases.
